(19) United States
(12) Patent Application Publication
(10) Pub. No.: US 2017/0037684 A1
(43) Pub. Date: Feb. 9, 2017

(54) BACKWARD WHIRLING REDUCTION

(71) Applicant: SCHLUMBERGER TECHNOLOGY CORPORATION, Sugar Land, TX (US)

(72) Inventor: Jahir PABON, Newton, MA (US)

(21) Appl. No.: 15/304,496

(22) PCT Filed: Apr. 6, 2015
(86) PCT No.: PCT/US2015/024505

§ 371 Date: Oct. 14, 2016

Related U.S. Application Data
(60) Provisional application No. 61/979,427, filed on Apr. 14, 2014.
(60) Provisional application No. 61/979,429, filed on Apr. 14, 2014.

(51) Int. Cl. E21B 7/00; G06F 17/50; E21B 17/10

(52) U.S. Cl. CPC E21B 7/00; E21B 17/1078; G06F 17/5086; E21B 47/12

(57) ABSTRACT

Backward whirling reduction is provided. In one possible implementation a system for reducing backward whirling includes a drill, a bottom hole assembly associated with the drill, and at least one backward whirling disruptor associated with the bottom hole assembly. In another possible implementation, information from a computer simulation associated with a behavior of the bottom hole assembly during a simulated drilling operation is accessed. Then a first section of the bottom hole assembly exhibiting backward whirling during the simulated drilling operation is identified and the bottom hole assembly is modified to include one or more backward whirling disruptors to at least reduce the backward whirling during the simulated drilling operation.

### RELATED APPLICATIONS

This application claims the benefit of and priority to U.S. Provisional Application Ser. No. 61/979,427 filed Apr. 14, 2014, and U.S. Provisional Application Ser. No. 61/979,429, filed Apr. 14, 2014, both of which are incorporated by reference herein.

### BACKGROUND

Existing methods known in the art for drilling in earthen formations or other non-homogenous and relatively hard mediums may encounter several difficulties, especially at deeper depths using extended drill strings and bottom hole assemblies. One potential concern, backward whirling, may be encountered when an imbalanced rotation or lateral movement of a bottom hole assembly causes impact, even briefly, with a borehole wall.

This can result in both lost energy and slower overall rotation of the bottom hole assembly, but it can also result in possible damage to the borehole and equipment such as the bottom hole assembly.

### SUMMARY

Backward whirling reduction is provided. In one possible implementation a system for reducing backward whirling includes a drill, a bottom hole assembly associated with the drill, and at least one backward whirling disruptor associated with the bottom hole assembly. In another possible implementation, information from a computer simulation associated with a behavior of a bottom hole assembly during a simulated drilling operation is accessed. Then a first section of the bottom hole assembly exhibiting backward whirling during the simulated drilling operation is identified and the bottom hole assembly is modified to include one or more backward whirling disruptors to at least reduce the backward whirling during the simulated drilling operation. In another possible implementation, a backward whirling disruptor can include an eccentricity associated with a portion of a bottom hole assembly disrupting a symmetry of the portion of the bottom hole assembly. Similarly, the backward whirling disruptor can include a mass imbalance associated with a section of the bottom hole assembly. Moreover the backward whirling disruptor can include two or more stabilizers of different outside diameters located at different positions on the bottom hole assembly.

This summary is not intended to identify key or essential features of the claimed subject matter, nor is it intended to be used as an aid in limiting the scope of the claimed subject matter.

### BRIEF DESCRIPTION OF THE DRAWINGS

Features of the described implementations can be more readily understood by reference to the following description taken in conjunction with the accompanying drawings.

FIG. 1 illustrates an example wellsite in which embodiments of backward whirling reduction can be employed;

FIG. 2 illustrates an example computing device that can be used in accordance with various implementations of backward whirling reduction;

FIG. 3 illustrates an example bottom hole assembly that can be used in accordance with various implementations of backward whirling reduction;

FIG. 4 illustrates example effects on a bottom hole assembly due to backward whirling in accordance with various implementations of backward whirling reduction;

FIG. 5 depicts various backward whirling disruptors that can be used in various implementations of backward whirling reduction;

FIG. 6 depicts various backward whirling disruptors that can be used in various implementations of backward whirling reduction;

FIG. 7 depicts various backward whirling disruptors that can be used in various implementations of backward whirling reduction; and

FIG. 8 illustrates an example method associated with various implementations of backward whirling reduction.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

Additionally, some examples discussed herein involve technologies associated with the oilfield services industry. It will be understood however that the techniques of backward whirling reduction can be used in a wide range of industries outside of the oilfield services sector, including for example, mining, geological surveying, etc.

As described herein, various techniques and technologies associated with backward whirling reduction can facilitate the reduction, or elimination, of backward whirling in a drilling operation. In one implementation, this can be accomplished through the addition of one or more backward whirling disruptors to a bottom hole assembly. Backward whirling disruptors can include one or more of: one or more eccentricities disrupting a symmetry of the bottom hole assembly; one or more mass imbalances associated with at least a portion of the bottom hole assembly; and at least one stabilizer on the bottom home assembly having an outside diameter differing from the outside diameters of other stabilizers located at other positions on the bottom hole assembly.

### Example Wellsite

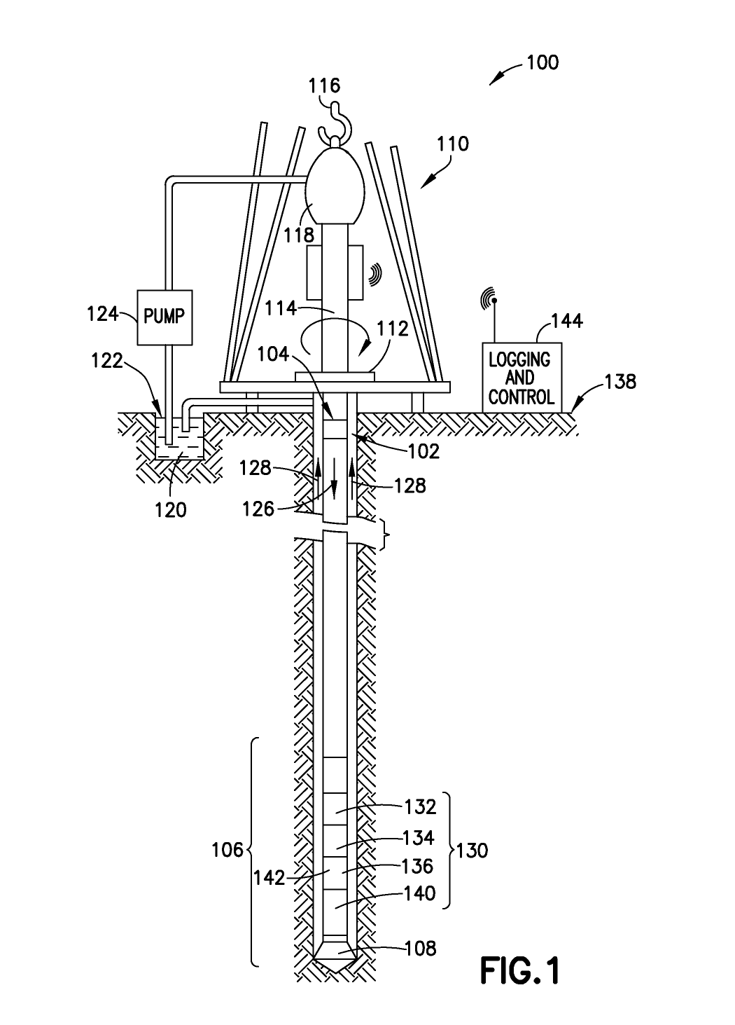

FIG. 1 illustrates a wellsite 100 in which embodiments of backward whirling reduction can be employed. Wellsite 100 can be onshore or offshore. In this example system, a borehole 102 is formed in a subsurface formation by rotary drilling in a manner that is well known. Embodiments of backward whirling reduction can also be employed in association with wellsites where directional drilling is being conducted.

A drill string 104 can be suspended within borehole 102 and have a bottom hole assembly 106 including a drill bit 108 at its lower end. The surface system can include a platform and derrick assembly 110 positioned over borehole 102. The assembly 110 can include a rotary table 112, kelly 114, hook 116 and rotary swivel 118. Drill string 104 can be rotated by rotary table 112, energized by means not shown, which engages kelly 114 at an upper end of drill string 104. Drill string 104 can be suspended from hook 116, attached to a traveling block (also not shown), through kelly 114 and a rotary swivel 118 which can permit rotation of drill string 104 relative to hook 116. As is well known, a top drive system can also be used.

In the example of this embodiment, the surface system can further include drilling fluid or mud 120 stored in a pit 122 formed at wellsite 100. A pump 124 can deliver drilling fluid 120 to an interior of drill string 104 via a port in swivel 118, causing drilling fluid 120 to flow downwardly through drill string 104 as indicated by directional arrow 126. Drilling fluid 120 can exit drill string 104 via ports in drill bit 108, and circulate upwardly through the annulus region between the outside of drill string 104 and wall of the borehole 102, as indicated by directional arrows 128. In this well-known manner, drilling fluid 120 can lubricate drill bit 108 and carry formation cuttings up to the surface as drilling fluid 120 is returned to pit 122 for recirculation.

Bottom hole assembly 106 of the illustrated embodiment can include drill bit 108 as well as a variety of equipment 130, including a logging-while-drilling (LWD) module 132, a measuring-while-drilling (MWD) module 134, a roto-steerable system and motor, various other tools, etc.

In one possible implementation, LWD module 132 can be housed in a special type of drill collar, as is known in the art, and can include one or more of a plurality of known types of logging tools (e.g., a nuclear magnetic resonance (NMR system), a directional resistivity system, and/or a sonic logging system). It will also be understood that more than one LWD and/or MWD module can be employed (e.g. as represented at position 136). (References, throughout, to a module at position 132 can also mean a module at position 136 as well). LWD module 132 can include capabilities for measuring, processing, and storing information, as well as for communicating with surface equipment.

MWD module 134 can also be housed in a special type of drill collar, as is known in the art, and include one or more devices for measuring characteristics of the well environment, such as characteristics of the drill string and drill bit. MWD module 134 can further include an apparatus (not shown) for generating electrical power to the downhole system. This may include a mud turbine generator powered by the flow of drilling fluid 120, it being understood that other power and/or battery systems may be employed. MWD module 134 can include one or more of a variety of measuring devices known in the art including, for example, a weight-on-bit measuring device, a torque measuring device, a vibration measuring device, a shock measuring device, a stick slip measuring device, a direction measuring device, and an inclination measuring device.

Various embodiments of the present disclosure can be associated with systems and methods for transmitting information (data and/or commands) from equipment 130 to a surface 138 of the wellsite 100. In one implementation, the information can be received by one or more sensors 140. The sensors 140 can be located in a variety of locations and can be chosen from any sensing and/or detecting technology known in the art, including those capable of measuring various types of radiation, electric or magnetic fields, including electrodes (such as stakes), magnetometers, coils, etc.

In one possible implementation, sensors 140 receive information from equipment 130, including LWD data and/or MWD data, which can be utilized for a variety of purposes including detecting backward whirling, steering drill 108 and any tools associated therewith, characterizing a formation surrounding borehole 102, characterizing fluids within wellbore 102, etc.

In one possible embodiment, in order to decrease, or fully eliminate, backward whirling one or more backward whirling disruptors 142 can be implemented on bottom hole assembly 106. Backward whirling disruptors 142 can include one or more of: one or more eccentricities disrupting a symmetry of bottom hole assembly 106; one or more mass imbalances associated with at least a portion of bottom hole assembly 106, and at least one stabilizer on bottom home assembly 106 having an outside diameter differing from the outside diameters of other stabilizers located at other positions on bottom hole assembly 106.

In one implementation a logging and control system 144 can be used to coordinate sensors 140 and/or associate information detected by sensors 140 with various phenomena associated with bottom hole assembly 106, including backward whirling. Logging and control system 144 can also be used with a wide variety of oilfield applications, including logging while drilling, artificial lift, measuring while drilling, wireline, etc. In one possible implementation, logging and control system 144 can be used to run various computer simulations on bottom hole assembly 106 under various drilling conditions to model possible backward whirling effects. In one possible embodiment, these simulations can also be used to model the effects of one or more backward whirling disruptors implemented on bottom hole assembly 106 to decrease and/or prevent backward whirling.

Logging and control system 144 can be located at surface 138, below surface 138, proximate to borehole 102, remote from borehole 102, or any combination thereof.

Alternately, or additionally, simulations on bottom hole assembly 106 can be processed at one or more other locations, including any configuration known in the art, such as in one or more handheld devices proximate and/or remote from the wellsite 100, at a computer located at a remote command center, in the logging and control system 144 itself, etc.

### Example Computing Device

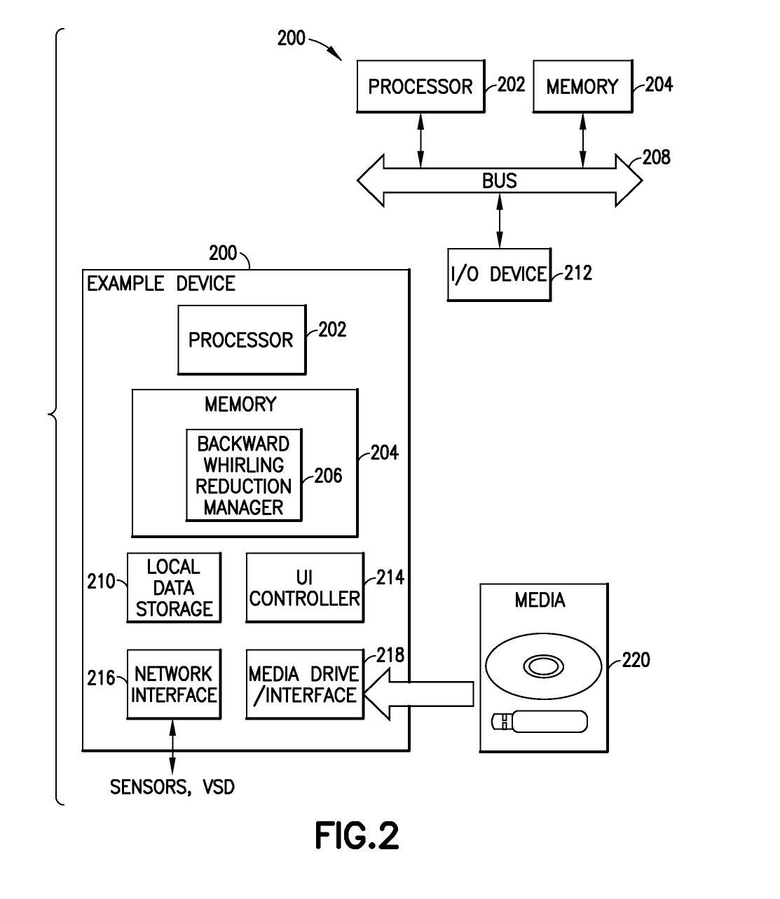

FIG. 2 shows an example device 200, with a processor 202 and memory 204 for hosting a backward whirling reduction manager 206 configured to implement various embodiments of backward whirling reduction as discussed in this disclosure, including running computer simulations of bottom hole assembly 106 in various drilling conditions and evaluating the performance of various backward whirling disruptors 142. Memory 204 can also host one or more databases and can include one or more forms of volatile data storage media such as random access memory (RAM)), and/or one or more forms of nonvolatile storage media (such as read-only memory (ROM), flash memory, and so forth).

Device 200 is one example of a computing device or programmable device, and is not intended to suggest any limitation as to scope of use or functionality of device 200 and/or its possible architectures. For example, device 200 can comprise one or more computing devices, programmable logic controllers (PLCs), etc.

Further, device 200 should not be interpreted as having any dependency relating to one or a combination of components illustrated in device 200. For example, device 200 may include one or more of a computer, such as a laptop computer, a desktop computer, a mainframe computer, etc., or any combination or accumulation thereof.

Device 200 can also include a bus 208 configured to allow various components and devices, such as processors 202, memory 204, and local data storage 210, among other components, to communicate with each other.

Bus 208 can include one or more of any of several types of bus structures, including a memory bus or memory controller, a peripheral bus, an accelerated graphics port, and a processor or local bus using any of a variety of bus architectures. Bus 208 can also include wired and/or wireless buses.

Local data storage 210 can include fixed media (e.g., RAM, ROM, a fixed hard drive, etc.) as well as removable media (e.g., a flash memory drive, a removable hard drive, optical disks, magnetic disks, and so forth).

A input/output (I/O) device 212 may also communicate via a user interface (UI) controller 214, which may connect with I/O device 212 either directly or through bus 208.

In one possible implementation, a network interface 216 may communicate outside of device 200 via a connected network, and in some implementations may communicate with hardware, such as one or more sensors 140, etc.

In one possible embodiment, sensors 140 may communicate with system 200 as input/output devices 212 via bus 208, such as via a USB port, for example.

A media drive/interface 218 can accept removable tangible media 220, such as flash drives, optical disks, removable hard drives, software products, etc. In one possible implementation, logic, computing instructions, and/or software programs comprising elements of backward whirling reduction manager 206 may reside on removable media 220 readable by media drive/interface 218.

In one possible embodiment, input/output devices 212 can allow a user to enter commands and information to device 200, and also allow information to be presented to the user and/or other components or devices. Examples of input devices 212 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes of backward whirling reduction manager 206 may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

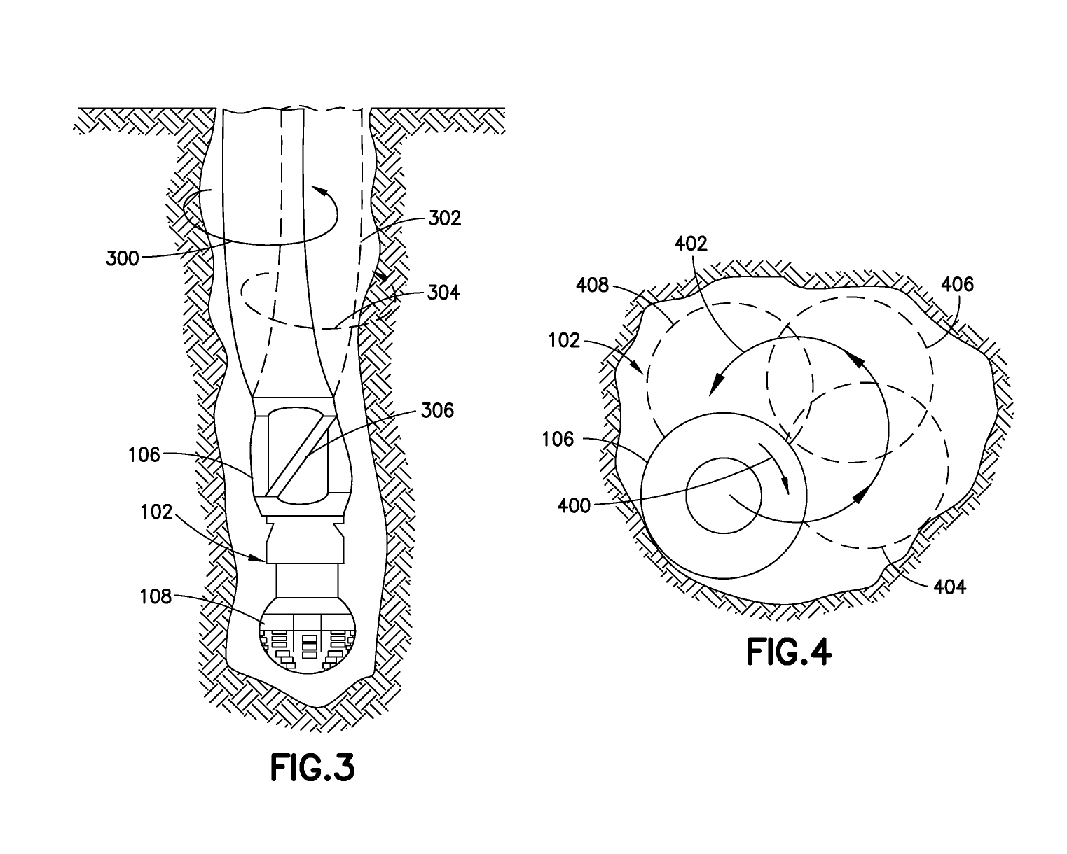

FIG. 3 illustrates bottom hole assembly 106 under the effects of backward whirling. For example, as bottom hole assembly 106 rotates in the direction of arrow 300 and experiences backward whirling, bottom hole assembly 106 can flex as shown by dashed lines 302, while continuing to rotate within borehole 102 as shown by arrow 304.

Backward whirling can be instigated by a variety of factors including when a portion of bottom hole assembly 106 impacts the wall of borehole 102 as borehole assembly 106 spins during a drilling operation. When this happens, the point of contact on bottom hole assembly 106 contacting the wall of borehole 102 may be urged to rotate in a direction opposite to the rotational direction of bottom hole assembly 106.

In one possible example, backward whirling can be caused by one or more stabilizers 306 on bottom hole assembly 106 contacting the wall of borehole 102. In another possible example, backward whirling can be caused by a damaged exterior of bottom hole assembly 106 contacting the wall of borehole 102. In another possible example, backward whirling can be caused by a non symmetric construction of bottom hole assembly 106. Similarly, in another possible example, backward whirling can be caused by a non symmetric loading of bottom hole assembly such as, for example, putting a piece of equipment 130 on one side of bottom hole assembly 106 and not matching it with an equivalent piece of equipment 130 on an opposing side of bottom hole assembly 106.

FIG. 4 illustrates bottom hole assembly 106 viewed from underneath drill bit 108 as bottom hole assembly 106 undergoes the effects of backward whirling as shown in FIG. 3. As illustrated, while bottom hole assembly 106 turns in direction 400, backward whirling can cause bottom hole assembly 106 to rotate around a cross sectional area of borehole 102 in a manner shown by arrow 402. As bottom hole assembly 106 rotates around borehole 102, it can occupy subsequent positions 404, 406, 408 and contact the wall of borehole 102 at various times. As backward whirling increases, more frequent, larger amplitude shocks may occur to bottom hole assembly 106 as it is whipped around inside of borehole 102.

These contacts between bottom hole assembly 106 and borehole 102 can result in various detrimental effects, including for example, an unintended widening of borehole 102, loss in vertical drilling speed of bottom hole assembly 106, and damage (such as, for example, lateral bending) to a variety of equipment including drill bit 108, equipment 130, and bottom hole assembly 106. In some cases these detrimental effects can result in time consuming and expensive fishing-out operations to replace prematurely worn or broken equipment.

In one implementation, the effects of backward whirling can be decreased, or fully eliminated, through the use of one or more types of backward whirling disruptors 142 designed to interfere with a tendency of bottom hole assembly 106 to backward whirl while under operation. For example, backward whirling disruptors 142 can include one or more eccentricities that disrupt a symmetry of bottom hole assembly 106. Additionally, backward whirling disruptors 142 can include at least one mass imbalance associated with at least one portion of bottom hole assembly 106. Moreover, backward whirling disruptors can also include two or more stabilizers of different outside diameters located at different positions on bottom hole assembly 106.

In one possible embodiment, a single type of backward whirling disruptor 142 can be used to decrease or eliminate backward whirling. For example, one mass imbalance may be sufficient to decrease or eliminate backward whirling.

In another possible embodiment, several backward whirling disruptors 142 of the same type may be deployed to decrease or eliminate backward whirling. For example, several eccentricities may be implemented to decrease or eliminate backward whirling.

In yet another possible implementation, several types of backward whirling disruptors 142, in any possible combination, may be deployed to decrease or eliminate backward whirling. For example, one eccentricity and two mass imbalances may be implemented to decrease or eliminate backward whirling. In yet another possible example, one mass imbalance and two or more stabilizers of different outside diameters located at different positions on bottom hole assembly 106 may be implemented to decrease or eliminate backward whirling.

### Example Backward Whirling Disruptors

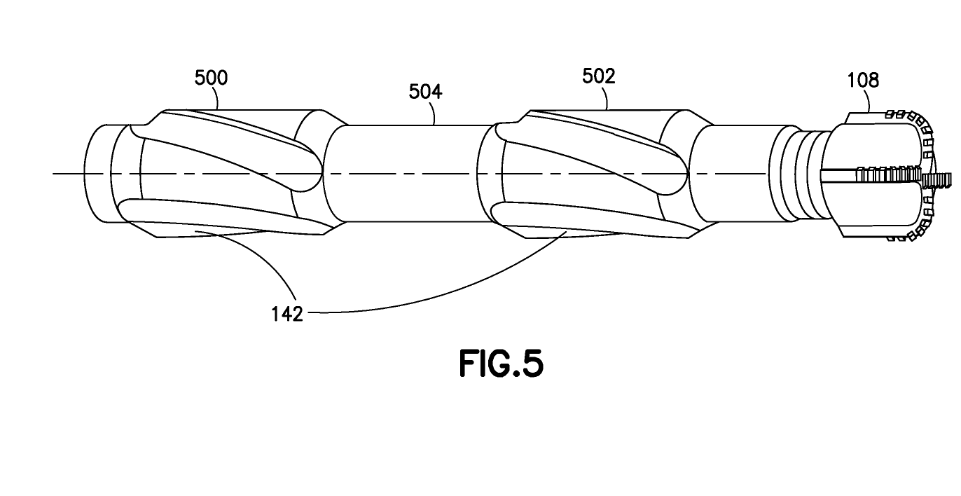

FIG. 5 illustrates bottom hole assembly 106 with an example backward whirling disruptor 142 in accordance with various implementations of backward whirling reduction. As illustrated, backward whirling disruptor 142 includes two stabilizers 500 and 502 located at different positions on bottom hole assembly 106. Stabilizers 500 and 502 have different outside diameters such that they interfere with the tendencies of each other to undergo backward whirling. This negative interference can slow or stop a backward whirling of bottom hole assembly 106.

It will be understood that more than two stabilizers can also be used with bottom hole assembly 106 in order to create one or more backward whirling disruptors 142. In such an implementation, at least one of the stabilizers will have a different diameter than the others in order to constitute a backward whirling disruptor 142.

In one possible implementation, as a drilling speed (“RPMdrill”) of drill bit 108 increases, backward whirling speed (“RPMwhirl”) can increase as the difference between a diameter of borehole 102 (“Dborehole”) and a diameter of bottom hole assembly 106 (“DBHA”) decreases per the equation:

$${RPM}_{whirl} = - \frac{{D}_{BHA}}{{D}_{borehole} - {D}_{BHA}} {RPM}_{drill} \qquad ( 1 )$$

Since bottom hole assembly 106 is generally in contact with the wall of borehole 102 via stabilizers 500, 502, backward whirling can often start at stabilizers 500, 502 and propagate to adjacent sections of bottom hole assembly 106.

If neighboring stabilizers 500, 502 have the same outer diameters, stabilizers 500, 502 will exhibit the same backward whirling speeds. Therefore, when one of the stabilizers (for example 500) starts backward whirling it can induce the neighboring stabilizer (for example 502) into backward whirling too. When this happens, a section 504 of bottom hole assembly 106 in between stabilizers 500, 502 can be forced into large and often chaotic lateral vibrations. In some instances, these lateral vibrations can result in extensive damage to bottom hole assembly 106, equipment 130, borehole 102, etc.

As illustrated in FIG. 5, a backward whirling disruptor 142 can be added to bottom hole assembly 106 by choosing stabilizers 500, 502 having slightly different outer diameters, and therefore different characteristic back whirling speeds.

For example, in one possible implementation, a radial clearance (i.e. half of a difference in diameter) between the outer diameter of a stabilizer (such as stabilizer 500 or 502) and the wall of borehole 102 can be small, such as approximately 0.0625 inches or less. Therefore, in accordance with equation (1) above, small changes in the outer diameters of stabilizers 500, 502 can achieve large differences in back whirling speeds.

For instance, in one possible implementation, if an outer diameter of a stabilizer is 5.875 inches and a diameter of borehole 102 is 6 inches, and if bottom hole assembly 106 is turned at 150 RPM, equation 1 above gives a backward whirling speed of 7050 RPM. A change in the outer diameter of the stabilizer of +/−0.0625 inches, can result in quite different backward whirling speeds of 14250 RPM and 4650 RPM.

The numbers in the preceding example are used solely for illustrative purposes, and it will be understood that a wide variety of borehole 102 diameters and stabilizer outer diameters can be used. For example, a common diameter such as 12.25 inches can be used for borehole 102, along with a variety of stabilizer outer diameter sizes, such as 12.125 inches, 12 inches, 11.875 inches, etc. In another possible example, a borehole 102 diameter of 8.5 inches can be used, with a variety of stabilizer outer diameters, such as 8.375 inches, 8.25 inches, etc.

Therefore, by utilizing stabilizers 500, 502 of different outside diameters on bottom hole assembly 106 (even if the difference in outside diameters is small) appreciable differences in characteristic backward whirling speeds can be created between neighboring stabilizers 500, 502, effectively reducing and/or eliminating a tendency of either stabilizer 500, 502 to induce the other stabilizer 500, 502 into backward whirling.

Bottom hole assembly 106 can operate differently under different drilling conditions. Therefore, in one possible implementation, expected drilling conditions can be used to determine how much of a difference in the outer diameters of stabilizers 500 and 502 can be sufficient to suppress to a desirable level the tendency of bottom hole assembly 106 to undergo backward whirling.

In one possible implementation, this can be done through a series of simulations, including computer simulations. In one possible aspect, the simulations can start with stabilizers 500, 502 having an equal outer diameter in order to identify sections of bottom hole assembly 106 prone to backward whirling. Then, different outer diameters may be assigned to stabilizers 500, 502 in sections of bottom hole assembly 106 prone to backward whirling, until the backward whirling tendency is suppressed to a desirable level (which may include eliminating backward whirling altogether).

In another possible implementation, backward whirling disruptor 142 can include one or more eccentricities configured to disrupt a symmetry of at least a portion of bottom hole assembly 106, making it easier for bottom hole assembly 106 to bend in one direction than another.

For example, in one possible embodiment, one or more sections of bottom hole assembly 106 can be designed to exhibit bending anisotropy such that bottom hole assembly 106 will exhibit different behavior along different directions of bending.

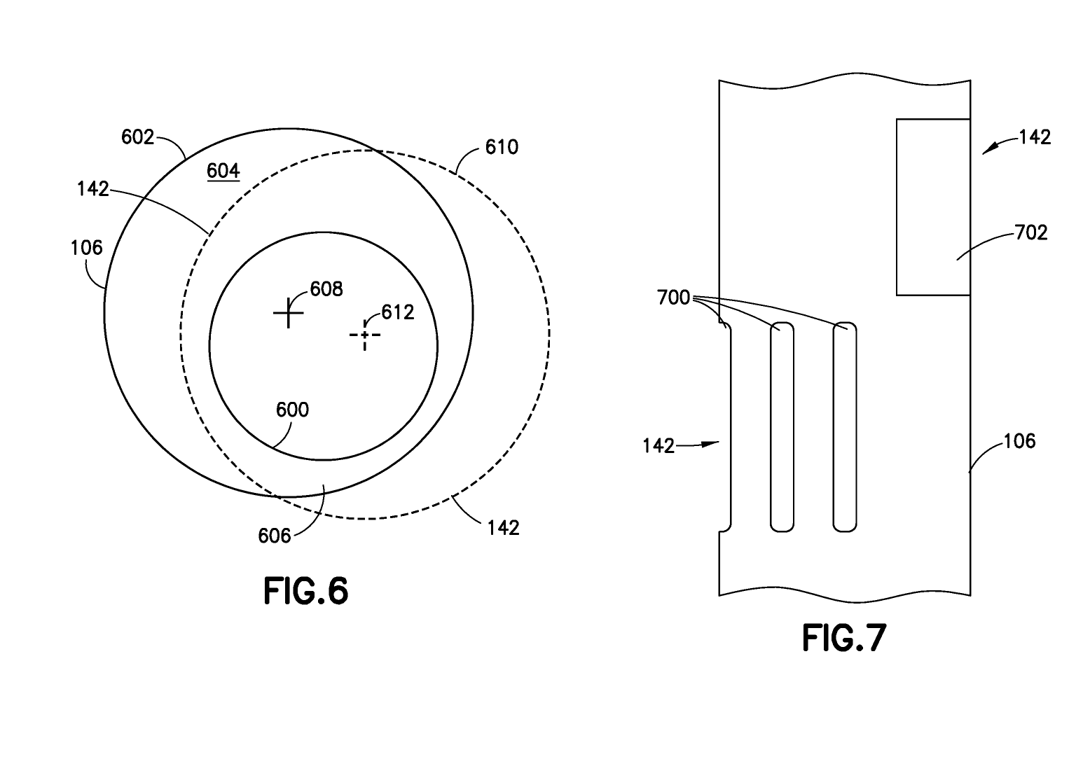

FIG. 6 provides a cross sectional view of bottom hole assembly 106 with example backward whirling disruptors 142 in accordance with various implementations of backward whirling reduction. As illustrated in FIG. 6, the symmetry of bottom hole assembly 106 can be disrupted by, for example, varying an inner wall 600 of bottom hole assembly 106 relative to an outer wall 602 of bottom hole assembly 106 to create areas 604, 606 of varying thickness in bottom hole assembly 106.

Similarly, backward whirling disruptor 142 can be implemented by using various equipment (including equipment 130, stabilizers, etc.) on bottom hole assembly 106, with the equipment having a centerline differing from (i.e. nonconcentric with) a centerline 608 of bottom hole assembly 106.

For example, a controlled amount of eccentricity at one or more stabilizers 610 (shown with dashed lines for clarity of illustration) can be introduced into bottom hole assembly 106, such that a centerline 612 of the one or more stabilizers 610 differs from centerline 608 of bottom hole assembly 106. As a result, for bottom hole assembly 106 to remain in contact with the wall of borehole 102 via stabilizer 610, different degrees of bending in portions of bottom hole assembly 106 will be involved depending on the orientation of bottom hole assembly 106.

In one possible implementation, such bending can create different tendencies for backward whirling in areas of bend than in areas of bottom hole assembly 106 without a bend. These differing tendencies can be exploited to disrupt each other, decreasing and/or totally eliminating a tendency of the entire bottom hole assembly 106 to backward whirl.

It will be understood that the symmetry of bottom hole assembly 106 can be disrupted in one or more areas, as desired, to disrupt backward whirling. For example, in one possible implementation, the symmetry of a single portion of bottom hole assembly 106 can be disrupted. The anisotropic behavior thereby induced can result in differing amounts of bending energy along different directions, with bottom hole assembly 106 tending to remain bent in a direction of low or minimal energy. As such, bottom hole assembly 106 can exhibit a resistance to go into backward whirling, forcing a direction of bending to rapidly change.

In one possible embodiment, eccentricities associated with bottom hole assembly capable of functioning as backward whirling disruptors 142 can be activated when desired. For example, in a normal operating mode, centerline 612 of stabilizer 610 can coincide with centerline 608 of bottom hole assembly 106. Then, when desired, stabilizer 610 can be activated to move such that centerline 612 of stabilizer 610 moves away from centerline 608 of bottom hole assembly. In one possible embodiment, the amount of movement of stabilizer 610 can also be controlled.

In one possible implementation, the type and/or amount of eccentricities to be used, the degrees of eccentricity to be used, and/or the locations on bottom hole assembly 106 where the eccentricities can be used, can be determined through one or more simulations, including any computer simulations known in the art. For example, in one possible aspect, simulations can start with bottom hole assembly 106 having no backward whirling disruptors 142 in order to identify sections of bottom hole assembly 106 prone to backward whirling. Different eccentricities may then be implemented in sections of bottom hole assembly 106 prone to backward whirling, until the backward whirling tendency is suppressed to a desirable level (which may include eliminating backward whirling altogether).

In another possible implementation, backward whirling disruptor 142 can include one or more mass imbalances associated with at least one portion of bottom hole assembly 106. For example, when a controlled amount of mass imbalance is present along a section of bottom hole assembly 106, a centrifugal effect due to the rotation of bottom hole assembly 106 can tend to keep bottom hole assembly 106 bent in a direction such that a center of mass of bottom hole assembly 106 will be located away from a nominal (unbent) centerline of bottom hole assembly 106. In one possible embodiment, tendencies toward forward whirling produced by these bends (i.e. tendencies of bottom hole assembly 106 to remain bent in a given direction resisting changes to bend in other directions) can be used to disrupt tendencies toward backward whirling in these and/or other areas of bottom hole assembly 106, such that backward whirling in bottom hole assembly 106 can be reduced to acceptable levels.

FIG. 7 illustrates bottom hole assembly 106 with example backward whirling disruptors 142 implemented though mass imbalances in accordance with various implementations of backward whirling reduction. Mass imbalances can be implemented in any way known in the art. For example, one or more disruption grooves 700 can be asymmetrically placed in bottom hole assembly 106. The depth, width, length, etc., of grooves 700 can be customized to effect a desired mass imbalance. Also a number and location of grooves 700 on bottom hole assembly 106 can be varied in accordance with the amount of mass imbalance desired. For example, as shown in FIG. 7, groves 700 can be located on one side of bottom hole assembly 106 and not the other. Also, grooves 107 can be left unfilled, or they can be filled with material lighter or heavier than that used to construct bottom hole assembly 106.

In addition to being located on a surface of bottom hole assembly 106, grooves 700 can also be located within bottom hole assembly 106. For example, grooves 700 can include voids within bottom hole assembly 106 that can be filled with air and/or materials lighter or heavier than that used to construct bottom hole assembly 106.

A backward whirling disruptor 142 implemented though mass imbalance can also be created by including asymmetrically oriented equipment 702 (such as equipment 130, stabilizers, etc.) on bottom hole assembly 106. For example, rather than placing two pieces of the same equipment on opposing sides of bottom hole assembly 106, or distributing the equipment evenly around bottom hole assembly 106, asymmetrically oriented equipment 702 can be placed such that bottom hole assembly 106 becomes unbalanced at a location of the asymmetrically oriented equipment 702. This can include employing asymmetrically oriented equipment 702 of different weights, dimensions, densities, etc., on bottom hole assembly 106 such that bottom hole assembly 106 becomes unbalanced at a location of the asymmetrically oriented equipment 702.

Bottom hole assembly 106 can behave differently under various drilling conditions, so various forms of mass imbalance can be used to suppress and/or eliminate a tendency of bottom hole assembly 106 towards backward whirling. This can include, for example, using various grooves 700 at various positions on bottom hole assembly 106, various asymmetrically oriented equipment 702 at various positions on bottom hole assembly 106, or any possible combination thereof.

In one possible implementation, the types and positions of mass imbalances to be employed as backward whirling disruptors 142 on bottom hole assembly 106 can be determined through use of various simulations, including computer simulations. For example, a series of simulations can be run starting with bottom hole assembly 106 devoid of backward whirling disruptors 142 to identify sections of bottom hole assembly 106 susceptible to backward whirling under one or more possible drilling operations. Different possible forms of mass imbalance can then be added to bottom hole assembly 106 to disrupt the backward whirling tendencies of the identified sections until the simulations show that the backward whirling tendency of bottom hole assembly 106 is reduced to an acceptable level.

It will be understood that multiple instances of the same form of backward whirling disruptor 142 can be used on a bottom hole assembly 102. For example, multiple instances of mass imbalances can be used to reduce or eliminate a tendency for bottom hole assembly 106 to backward whirl. Additionally, the various forms of backward whirling disruptor 142 can be combined in any way possible to reduce or eliminate a tendency for bottom hole assembly 106 towards backward whirling. For example several mass imbalances can be implemented with one or more eccentricities and one or more stabilizers of different outer diameters.

It will also be understood that the various possible simulations disclosed herein can take any form known in the art, and can include use of various techniques such as difference modeling, numerical modeling (including finite element modeling), etc.

### Example Methods

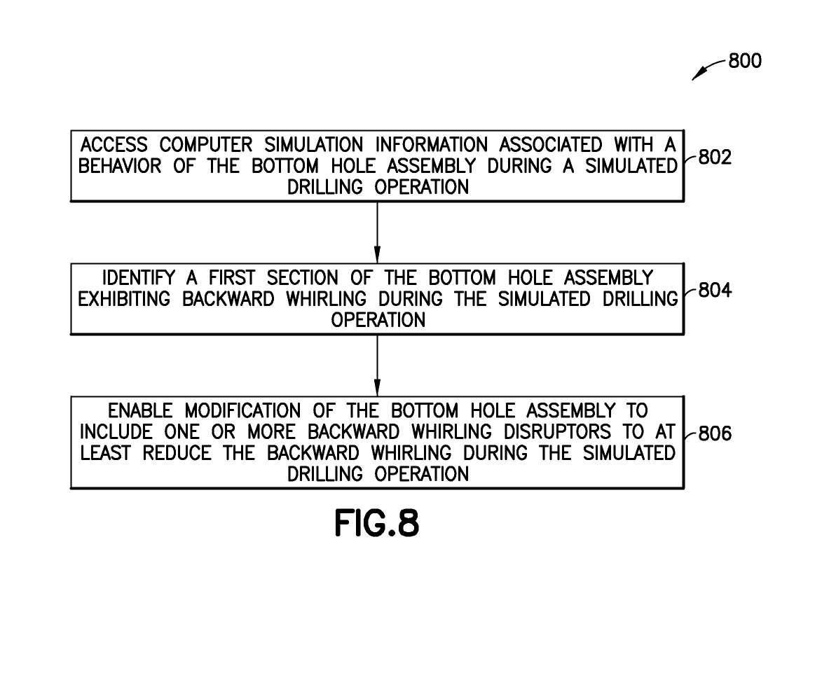

FIG. 8 illustrates an example method 800 for implementing aspects of backward whirling reduction. The method is illustrated as a collection of blocks and other elements in a logical flow graph representing a sequence of operations that can be implemented in hardware, software, firmware, various logic or any combination thereof. The order in which the method is described is not intended to be construed as a limitation, and any number of the described method blocks can be combined in any order to implement the method, or alternate methods. Additionally, individual blocks and/or elements may be deleted from the method without departing from the spirit and scope of the subject matter described therein. In the context of software, the blocks and other elements can represent computer instructions that, when executed by one or more processors, perform the recited operations. Moreover, for discussion purposes, and not purposes of limitation, selected aspects of the method may described with reference to elements shown in FIGS. 1-7.

At block 802, information from a computer simulation associated with a behavior of a bottom hole assembly (such as bottom hole assembly 106) during a simulated drilling operation is accessed. The computer simulation can take any form known in the art, and can include the use of various techniques such as difference modeling, numerical modeling (including for example finite element modeling), etc.

At block 804, a first section of the bottom hole assembly exhibiting backward whirling during the simulated drilling operation is identified. For example, perhaps the bottom hole assembly exhibits a tendency towards backward whirling at a stabilizer, such as stabilizer 500, 502. In one possible implementation, several sections of the bottom hole assembly susceptible to backward whirling can be identified in this manner.

At block 806, modification of the bottom hole assembly to include one or more backward whirling disruptors, such as backward whirling disruptors 142, can be enabled to at least reduce the backward whirling during the simulated drilling operation. This can be done by allowing a user to input desired backward whirling disruptors and their desired locations on the bottom hole assembly, or it can be done automatically by a computer program. Alternately, or additionally, the computer program can recommend one or more backward whirling disruptors with associated locations on the bottom hole assembly and allow a user to select which options to implement. Any type of backward whirling disruptor can be used, and any possible combination of types of backward whirling disruptors (including multiple instances of one or more types of backward whirling disruptors can be used). In one possible implementation backward whirling of the bottom hole assembly can be reduced through the addition of the one or more backward whirling disruptors. In another possible implementation, backward whirling of the bottom hole assembly can be eliminated through the addition of the one or more backward whirling disruptors.

Although a few examples have been described in detail above, those skilled in the art will readily appreciate that many modifications are possible in the examples without materially departing from this subject disclosure. Accordingly, all such modifications are intended to be included within the scope of this disclosure as defined in the following claims. In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A system for reducing backward whirling, the system comprising:
a drill;
a bottom hole assembly associated with the drill; and
at least one backward whirling disruptor associated with the bottom hole assembly.

2. The system of claim 1, wherein the at least one backward whirling disruptor includes one or more of:
at least one eccentricity associated with at least one portion of the bottom hole assembly disrupting a symmetry of the at least one portion of the bottom hole assembly;
at least one mass imbalance associated with at least one portion of the bottom hole assembly; and
two or more stabilizers of different outside diameters located at different positions on the bottom hole assembly.

3. The system of claim 2, wherein the at least one eccentricity includes at least one portion of the bottom hole assembly where a thickness of a wall of the bottom hole assembly is non uniform about a centerline of the bottom hole assembly.

4. The system of claim 2, wherein the at least one eccentricity includes at least one portion of the bottom hole assembly where equipment on the bottom hole assembly has a centerline nonconcentric with a centerline of the bottom hole assembly.

5. The system of claim 4, wherein the equipment includes one or more stabilizers.

6. The system of claim 2, wherein the at least one mass imbalance includes at least one disruption groove placed asymmetrically on the bottom hole assembly.

7. The system of claim 2, wherein the at least one mass imbalance includes at least one disruption groove placed asymmetrically within the bottom hole assembly.

8. The system of claim 2, wherein the at least one mass imbalance includes one or more pieces of equipment placed asymmetrically about the bottom hole assembly.

9. The system of claim 1, wherein the at least one backward whirling disruptor is configured to be activated as desired.

10. A computer-readable tangible medium with instructions stored thereon that, when executed, direct a processor to perform acts comprising:
access computer simulation information associated with a behavior of the bottom hole assembly during a simulated drilling operation;
identify a first section of the bottom hole assembly exhibiting backward whirling during the simulated drilling operation; and
enable modification of the bottom hole assembly to include one or more backward whirling disruptors to at least reduce the backward whirling during the simulated drilling operation.

11. The computer-readable medium of claim 10, further including instructions to direct a processor to perform acts comprising:
perform a computer simulation of the bottom hole assembly during a simulated drilling operation to produce the computer simulation information.

12. The computer-readable medium of claim 10, further including instructions to direct a processor to perform acts comprising:
perform a computer simulation of the bottom hole assembly during a simulated drilling operation to produce the computer simulation information using a numerical model.

13. The computer-readable medium of claim 10, further including instructions to direct a processor to perform acts comprising:
allow an operator to modify the bottom hole assembly to include the one or more backward whirling disruptors which comprise one or more of:
an eccentricity;
a mass imbalance; and
a second stabilizer of a different outside diameter to a first stabilizer located at another position on the bottom hole assembly.

14. The computer-readable medium of claim 10, further including instructions to direct a processor to perform acts comprising:
modify automatically the bottom hole assembly to include the one or more backward whirling disruptors which comprise one or more of:
an eccentricity;
a mass imbalance;
a second stabilizer of a different outside diameter to a first stabilizer located at another position on the bottom hole assembly.

15. The computer-readable medium of claim 10, further including instructions to direct a processor to perform acts comprising:
access additional computer simulation information from a further computer simulation regarding a behavior of the bottom hole assembly with the one or more backward whirling disruptors; and
assess if the one or more backward disruptors reduce the backward whirling to an acceptable level.

16. The computer-readable medium of claim 10, further including instructions to direct a processor to perform acts comprising:
accessing additional computer simulation information from one or more further computer simulations and iteratively adding one or more additional backward whirling disruptors to one or more sections of the bottom hole assembly to reduce the backward whirling to an acceptable level.

17. A bottom hole assembly associated with a drill, the bottom hole assembly comprising:
at least one backward whirling disruptor comprising one or more of:
an eccentricity associated with a portion of the bottom hole assembly disrupting a symmetry of the portion of the bottom hole assembly;
a mass imbalance associated with a section of the bottom hole assembly; and
two or more stabilizers of different outside diameters located at different positions on the bottom hole assembly.

18. The bottom hole assembly of claim 1, wherein the eccentricity comprises one or more of:
a portion of the bottom hole assembly where a thickness of a wall of the bottom hole assembly varies about a circumference of the bottom hole assembly;
a portion of the bottom hole assembly where equipment on the bottom hole assembly has a centerline nonconcentric with a centerline of the bottom hole assembly.

19. The bottom hole assembly of claim 17, wherein the mass imbalance comprises one or more of:
at least one disruption groove placed asymmetrically on the bottom hole assembly;
at least one disruption inclusion within the bottom hole assembly; and
one or more pieces of equipment placed asymmetrically about the bottom hole assembly.

20. The bottom hole assembly of claim 1, wherein the at least one backward whirling disruptor is configured to be activated as desired.
